(19) United States
(12) Patent Application Publication
(10) Pub. No.: US 2017/0041095 A1
(43) Pub. Date: Feb. 9, 2017

(54) DYNAMIC SELECTION OF ANALOG INTERFERENCE CANCELLERS

(71) Applicant: QUALCOMM Incorporated, San Diego, CA (US)

(72) Inventors: Insoo Hwang, San Diego, CA (US); Cong Nguyen, San Diego, CA (US); Won-ick Lee, San Diego, CA (US); Mark Maggenti, Del Mar, CA (US); Ozgur Dural, San Diego, CA (US)

(21) Appl. No.: 14/819,986

(22) Filed: Aug. 6, 2015

(51) Int. Cl. H04J 11/00; H04W 52/24; H04B 15/00

(52) U.S. Cl. CPC H04J 11/005; H04B 15/00; H04W 52/243

(57) ABSTRACT

A wireless device may determine the level of interference mitigation appropriate for the application and dynamically select a combination of interference cancellation components that satisfies that level. The combination of interference cancellation components may include components that consume power (e.g., active components) and components that do not consume power (e.g., passive components). The interference cancellation components may be used at the transmitter and/or the receiver. In some cases, the wireless device may also determine how much power is acceptable to expend on the interference mitigation. In such scenarios, the selection of the interference cancellation components may be such that the aggregated power consumption is less than the power expenditure limit.

### BACKGROUND

The following relates generally to wireless communication, and more specifically to dynamic selection of analog interference cancellers.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

In some cases, a wireless device may transmit and receive at the same time. In such scenarios, interference between the transmit signal and the receive signal may arise. The interference may fluctuate, but the gain provided by the interference cancellation components of the device may be fixed. Accordingly, the gain provided by the interference cancellation components may be insufficient for certain applications and excessive in other applications. Applying inappropriate interference cancellation may result in wasteful power expenditures or signals that are too distorted to process.

### SUMMARY

The present description discloses techniques for dynamically selecting combinations of analog interference cancellation components to perform interference mitigation. According to these techniques, a wireless device may determine the level of interference mitigation appropriate for the application and dynamically select a combination of interference cancellation components that satisfies that level. The combination of interference cancellation components may include components that consume power (e.g., active components) and components that do not consume power (e.g., passive components). The interference cancellation components may be used at the transmitter and/or the receiver. In some cases, the wireless device may also determine how much power is acceptable to expend on the interference mitigation. In such scenarios, the selection of the interference cancellation components may be such that the aggregated power consumption is less than the power expenditure limit.

A method of wireless communication is described. The method may include determining, for a wireless device, at least one of a target interference cancellation or a target power consumption, identifying a plurality of analog interference cancellers available for use in the wireless device, selecting a combination of the available analog interference cancellers based at least in part on the target interference cancellation or the target power consumption, and using the combination in a transceiver of the wireless device.

An apparatus for wireless communication is described. The apparatus may include means for determining, for a wireless device, at least one of a target interference cancellation or a target power consumption, means for identifying a plurality of analog interference cancellers available for use in the wireless device, means for selecting a combination of the available analog interference cancellers based at least in part on the target interference cancellation or the target power consumption, and means for using the combination in a transceiver of the wireless device.

A further apparatus for wireless communication is described. The apparatus may include a processor, memory in electronic communication with the processor, and instructions stored in the memory and operable, when executed by the processor, to cause the apparatus to determine, for a wireless device, at least one of a target interference cancellation or a target power consumption, identify a plurality of analog interference cancellers available for use in the wireless device, select a combination of the available analog interference cancellers based at least in part on the target interference cancellation or the target power consumption, and use the combination in a transceiver of the wireless device.

A non-transitory computer-readable medium storing code for wireless communication is described. The code may include instructions executable to determine, for a wireless device, at least one of a target interference cancellation or a target power consumption, identify a plurality of analog interference cancellers available for use in the wireless device, select a combination of the available analog interference cancellers based at least in part on the target interference cancellation or the target power consumption, and use the combination in a transceiver of the wireless device.

Some examples of the method, apparatuses, or non-transitory computer-readable medium described herein may further include processes, features, means, or instructions for determining that the target interference cancellation is below or equal to a threshold, and selecting the combination of analog interference cancellers includes selecting the combination to include a passive isolator and an active interference canceller. Other examples may include determining that the target interference cancellation is equal to or between a first threshold and a second threshold, and selecting the combination of analog interference cancellers includes selecting the combination to include a passive isolator and a feed-forward power amplifier (FFPA). Additionally or alternatively, some examples may include processes, features, means, or instructions for determining that the target interference cancellation is greater than or equal to a threshold, and selecting the combination of analog interference cancellers includes selecting the combination to include a passive isolator, a feed-forward power amplifier, and an active interference canceller.

Some examples of the method, apparatuses, or non-transitory computer-readable medium described herein may further include processes, features, means, or instructions for measuring a signal power at the transceiver, wherein the determination of the target interference cancellation is based at least in part on the measurement. Additionally or alternatively, some examples may include processes, features, means, or instructions for accessing a look-up table, the look-up table indicating one or more of an estimated power consumption and interference cancellation for possible combinations of analog interference cancellers, and selecting the combination of analog interference cancellers is based at least in part on the one or more estimated power consumption and interference cancellation for the possible combinations.

Some examples of the method, apparatuses, or non-transitory computer-readable medium described herein may further include processes, features, means, or instructions for comparing at least one of the target interference cancellation or the target power consumption to corresponding estimations for each combination of analog interference cancellers, and selecting the combination of analog interference cancellers is based at least in part on the comparison. Additionally or alternatively, some examples may include processes, features, means, or instructions for identifying a power margin for the wireless device, and determining the target power consumption is based at least in part on the identified power margin.

Some examples of the method, apparatuses, or non-transitory computer-readable medium described herein may further include processes, features, means, or instructions for identifying a priority associated with the wireless device, and determining the at least one of the target interference cancellation or the target power consumption is based at least in part on the identified priority. Additionally or alternatively, in some examples selecting the combination of analog interference cancellers includes selecting the combination to include one or more of a passive isolator, an active receiver noise canceller, or a passive transmitter noise canceller.

In some examples of the method, apparatuses, or non-transitory computer-readable medium described herein, selecting the combination of analog interference cancellers includes selecting the combination to include one or more passive analog interference cancellers and one or more active analog interference cancellers. In some examples of the method, apparatuses, or non-transitory computer-readable medium described herein, selecting the combination of analog interference cancellers includes selecting the combination to include one or more of a passive isolator, an active receiver noise canceller, or an active transmitter noise canceller. Additionally or alternatively, in some examples the plurality of analog interference cancellers includes one or more passive analog interference cancellers which include one or more of a passive filter, a duplexer, a hybrid transformer, or a circulator.

In some examples of the method, apparatuses, or non-transitory computer-readable medium described herein, the plurality of analog interference cancellers includes one or more active analog interference cancellers which include one or more of an active filter or a feed-forward power-amplifier. Additionally or alternatively, in some examples selecting the combination of analog interference cancellers includes selecting the combination to include a passive isolator, an associated tuning circuit, and an active analog interference canceller.

Some examples of the method, apparatuses, or non-transitory computer-readable medium described herein may further include processes, features, means, or instructions for detecting a plurality of antennas at the transceiver, and selecting the combination of analog interference cancellers includes selecting a combination of analog interference cancellers for each antenna of the plurality of antennas. Additionally or alternatively, some examples may include processes, features, means, or instructions for detecting a plurality of antennas at the transceiver, and sharing one or more analog interference cancellers of the selected combination between two or more antennas of the plurality of antennas.

The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

Aspects of the disclosure are described in reference to the following figures:

FIG. 1 illustrates an example of a wireless communications system that supports dynamic selection of analog interference cancellers in accordance with various aspects of the present disclosure;

FIG. 2 illustrates an example of a wireless communications subsystem that supports dynamic selection of analog interference cancellers in accordance with various aspects of the present disclosure;

FIG. 3 illustrates a block diagram of an interference cancellation configuration for dynamic selection of analog interference cancellers in accordance with various aspects of the present disclosure;

FIG. 4 illustrates a block diagram of an interference cancellation configuration for dynamic selection of analog interference cancellers in accordance with various aspects of the present disclosure;

FIG. 5 illustrates a block diagram of an interference cancellation configuration for dynamic selection of analog interference cancellers in accordance with various aspects of the present disclosure;

FIG. 6 illustrates a block diagram of an interference cancellation configuration for dynamic selection of analog interference cancellers in accordance with various aspects of the present disclosure;

FIG. 7 shows a block diagram of a wireless device that supports dynamic selection of analog interference cancellers in accordance with various aspects of the present disclosure;

FIG. 8 shows a block diagram of a wireless device that supports dynamic selection of analog interference cancellers in accordance with various aspects of the present disclosure;

FIG. 9 illustrates a block diagram of a system including a device that supports dynamic selection of analog interference cancellers in accordance with various aspects of the present disclosure;

FIG. 10 illustrates a block diagram of a system including a base station that supports dynamic selection of analog interference cancellers in accordance with various aspects of the present disclosure;

FIG. 11 illustrates a method for dynamic selection of analog interference cancellers in accordance with various aspects of the present disclosure; and

FIG. 12 illustrates a method for dynamic selection of analog interference cancellers in accordance with various aspects of the present disclosure.

### DETAILED DESCRIPTION

In this disclosure, a wireless communication device may dynamically change the components that are used for interference cancellation. For example, the wireless device may switch from using one interference cancellation configuration to using a different interference cancellation configuration. Each interference cancellation configuration may use a distinct combination of interference cancellation components to provide pre-determined levels of interference mitigation. The combination of interference cancellation components may be selected based on the cancellation needs of the wireless device. For example, the wireless device may determine a target level of interference cancellation and select the combination of interference cancellers that provides enough gain to satisfy the desired level. In some cases, the wireless device may also determine a power expenditure threshold that indicates the amount of power the wireless device may spend on interference mitigation. Accordingly, the wireless device may select the combination of interference cancellers that provides enough gain to satisfy the required interference cancellation without exceeding the power consumption limit.

Aspects of the disclosure are initially described in the context of a wireless communication system. Specific examples are then described for dynamic selection of analog interference cancellers. These and other aspects of the disclosure are further illustrated by and described with reference to apparatus diagrams, system diagrams, and flowcharts that relate to dynamic selection of analog interference cancellers.

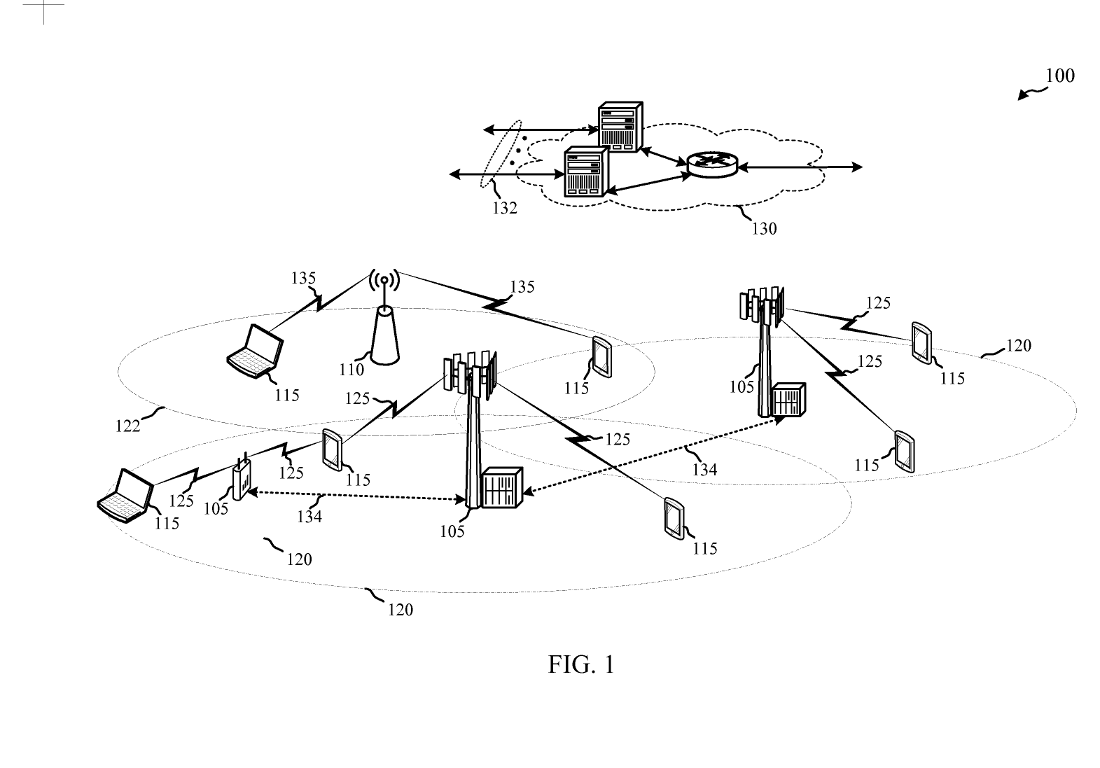

FIG. 1 illustrates an example of a wireless communications system 100 that supports dynamic selection of analog interference cancellers in accordance with various aspects of the present disclosure. The wireless communications system 100 may include base station(s) 105, access point(s) (AP) 110, and mobile devices such as UEs 115. The AP 110 may provide wireless communications via a wireless local area network (WLAN) radio access network (RAN) such as, e.g., a network implementing at least one of the IEEE 802.11 family of standards. The AP 110 may provide, for example, WLAN or other short range (e.g., Bluetooth and Zigbee) communications access to a UE 115. Each AP 110 has a geographic coverage area 122 such that UEs 115 within that area can typically communicate with the AP 110. UEs 115 may be multi-access mobile devices that communicate with the AP 110 and a base station 105 via different radio access networks. The UEs 115, such as mobile stations, personal digital assistants (PDAs), other handheld devices, netbooks, notebook computers, tablet computers, laptops, display devices (e.g., TVs, computer monitors, etc.), printers, etc., may be stationary or mobile and traverse the geographic coverage areas 122 and/or 120, the geographic coverage area of a base station 105. While only one AP 110 is illustrated, the wireless communications system 100 may include multiple APs 110. Some or all of the UEs 115 may associate and communicate with an AP 110 via a communication link 135 and/or with a base station 105 via a communication link 125.

The wireless communications system 100 may also include a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

A UE 115 can be covered by more than one AP 110 and/or base station 105 and can therefore associate with multiple APs 110 or base stations 105 at different times. For example, a single AP 110 and an associated set of UEs 115 may be referred to as a basic service set (BSS). An extended service set (ESS) is a set of connected BSSs. A distribution system (DS) (not shown) is used to connect APs 110 in an extended service set. A geographic coverage area 122 for an AP 110 may be divided into sectors making up only a portion of the geographic coverage area (not shown). The wireless communications system 100 may include APs 110 of different types (e.g., metropolitan area, home network, etc.), with varying sizes of geographic coverage areas and overlapping geographic coverage areas for different technologies. Although not shown, other wireless devices can communicate with the AP 110.

The base stations 105 may wirelessly communicate with the UEs 115 via base station antennas. Each of the base station 105 sites may provide communication coverage for a respective geographic coverage area 120. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 120 for a base station 105 may be divided into sectors making up only a portion of the geographic coverage area (not shown). The wireless communications system 100 may include base stations 105 of different types (e.g., macro and/or small cell base stations). There may be overlapping geographic coverage areas 120/122 for different technologies.

In some examples, the wireless communications system 100 includes portions of an LTE/LTE-Advanced (LTE-A) network. In LTE/LTE-A networks, the term evolved Node B (eNB) may be generally used to describe the base stations 105, while the term UE may be generally used to describe the UEs 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a geographic coverage area (e.g., sector, etc.) of a carrier or base station, depending on context.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations and network equipment including macro eNBs, small cell eNBs, relay base stations, APs, and the like.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include at least one carrier, where each carrier may be a signal made up of multiple sub-carriers (e.g., waveform signals of different frequencies) modulated according to the various radio technologies described above. In some cases, multiple carriers may be used (e.g., in a carrier aggregation (CA) scheme). Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined. Similarly, communication links 135, also shown in wireless communications system 100, may include UL transmissions from a UE 115 to an AP 110, and/or DL transmissions from an AP 110 to a UE 115.

In some embodiments of the wireless communications system 100, base stations 105, APs 110, and/or UEs 115 may include multiple antennas for employing antenna diversity schemes to improve communication quality and reliability between base stations 105, APs 110, and UEs 115. Additionally or alternatively, base stations 105, APs 110, and/or UEs 115 may employ multiple-input, multiple-output (MIMO) techniques that may take advantage of multi-path environments to transmit multiple spatial layers carrying the same or different coded data.

In some cases, a wireless device (e.g., a UE 115, base station 105, or AP 110) in the wireless communications system 100 may transmit and receive at the same time (e.g., using one or more antennas). In such cases, interference may occur between the transmit signals and the receive signals. Interference may cause deleterious effects (e.g., signal distortion) that impair communications. A wireless device may perform interference mitigation by use of analog interference cancellers that are designed to reduce noise and interference. An interference canceller may be any component that mitigates interference (e.g., by preventing or reducing interference, or counteracting the effects of interference). For example, an interference canceller may provide isolation between signals or cancel out interference-caused distortions. Thus, an interference canceller (or “cancellation component”) may be passive (i.e., the component may not consume power) or active (i.e., the component may consume power).

A wireless device may use a combination of analog interference cancellers to provide an aggregated gain that is sufficient to overcome the effects of interference. But interference may fluctuate depending on the communication application. To compensate for changes in interference, a wireless device may dynamically switch between using different combinations of interference cancellers. The selection of which combination of cancellation components to use may be based on the target interference cancellation (e.g., how much gain is required to mitigate the interference to an acceptable level). In some cases, the power expenditure of the wireless device may be taken into account when choosing which combination of interference cancellers to use. For example, the combination of cancellation components may be chosen so that their combined power consumption does not exceed a power expenditure threshold.

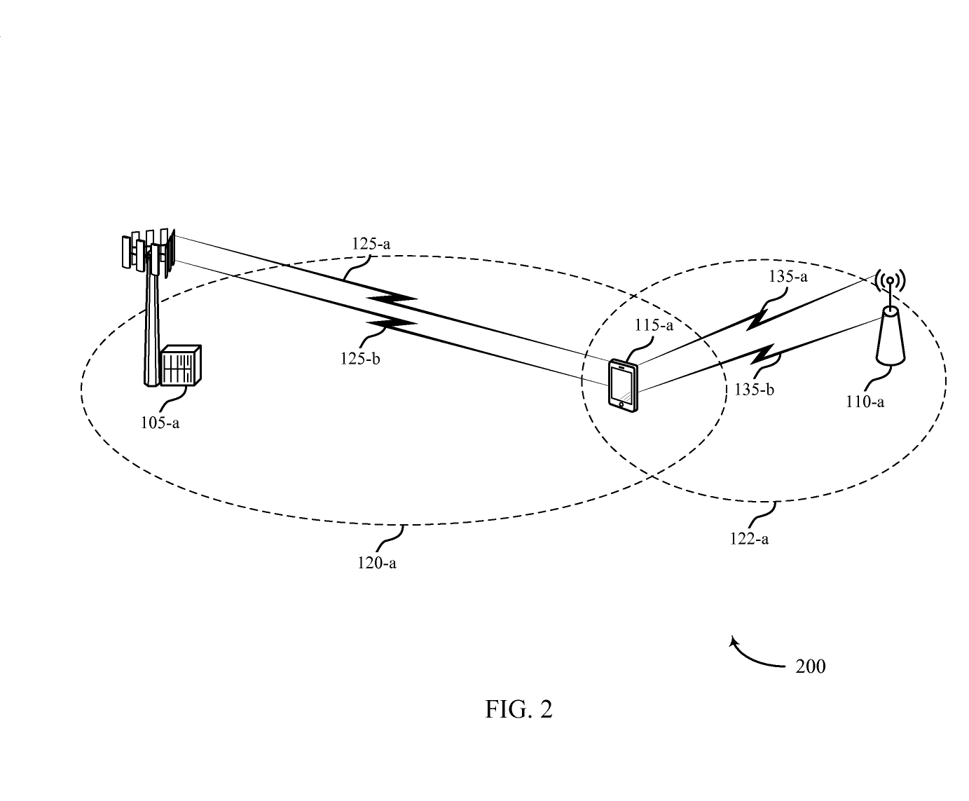

FIG. 2 illustrates an example of a wireless communications subsystem 200 for dynamic selection of analog interference cancellers in accordance with various aspects of the present disclosure. Wireless devices within wireless communications subsystem 200 may adaptively reconfigure their use of cancellation components to meet pre-determined interference cancellation requirements. Wireless communications subsystem 200 may include a UE 115-a, which may be at the intersection of coverage area 120-a for base station 105-a and coverage area 122-a for AP 110-a. UE 115-a, AP 110-a, and base station 105-a may be respective examples of a UE 115, AP 110, and base station 105 described with reference to FIG. 1.

UE 115-a may use a single antenna to communicate with base station 105-a (or AP 110-a). In one example, UE 115-a transmits signals to base station 105-a over communication link 125-a and receives signals from base station 105-a over communication link 125-b. The communications may be simultaneous and may be in the same or different frequency bands (e.g., the communications may be full-duplex or half-duplex). In some cases, UE 115-a may communicate simultaneously with two different wireless devices at the same time using the same antenna. For example, UE 115-a may use a single antenna to concurrently communicate with base station 105-a (e.g., over communication link 125-a or communication link 125-b) and AP 110-a (e.g., over communication link 135-a or communication link 135-b). Thus, WWAN and WLAN communications may, in some scenarios, share a single antenna. However, when single-antenna communications are at the same time, the stronger signal (or aggressor) (e.g., the transmit signal) may cause interference on the weaker signal (or victim) (e.g., the receive signal).

UE 115-a may detect such an interference scenario and dynamically select interference cancellation components that provide enough gain to overcome the interference. For example, the interference cancellation may provide separation sufficient to enable the concurrent operation of two radios using the same antenna. The cancellation components may be analog radio frequency (RF) interference cancellers. In some cases, UE 115-a may determine the amount of interference cancellation (e.g., gain) that is required to sufficiently overcome the interference. Once the target interference cancellation is determined, UE 115-a may evaluate combinations of interference cancelling components and select the combination that provides at least the target interference cancellation. The selection of interference cancellers may also be based on power requirements for the wireless device. For example, UE 115-a may determine that there is a limit on the power that can be used to perform interference mitigation. Accordingly, UE 115-a may select the combination of interference cancellers that not only satisfies the interference cancellation requirements but also consumes less power than the limit.

In some cases, UE 115-a may include multiple antennas for communication. For example, UE 115-a may engage in MIMO or CA communications which occur over multiple antennas simultaneously. In such cases, interference from one antenna may affect signaling for another antenna. Accordingly, UE 115-a may dynamically select combinations of interference cancellers for use at each antenna. In one example, each antenna has its own combination of interference cancellers. In another example, one or more antennas may share a combination of interference cancellers, or individual cancellation components. The selection of interference cancellers may be based on the interference cancellation requirements and/or the power requirements for the wireless device.

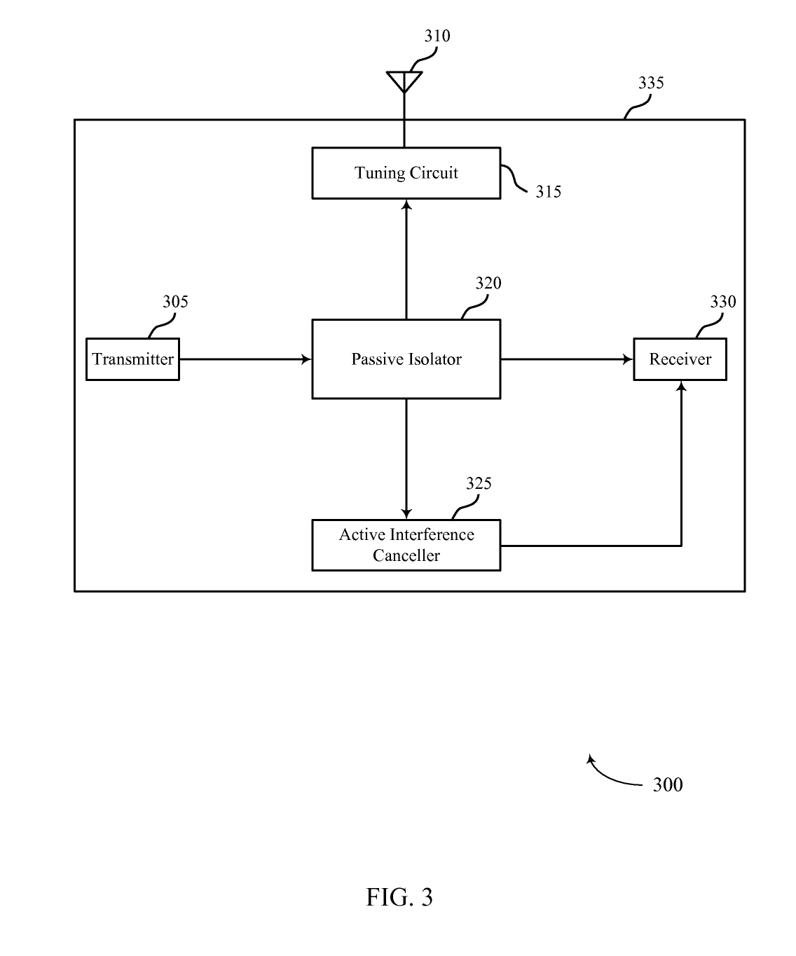

FIG. 3 shows a block diagram of an interference cancellation configuration 300 for dynamic selection of analog interference cancellers in accordance with various aspects of the present disclosure. Interference cancellation configuration 300 includes a transceiver 335 which may be included in a UE 115, AP 110, or base station 105 such as described in FIGS. 1 and 2. Transceiver 335 aggregates isolation provided by a passive isolator 320 and an active interference canceller 325. Although shown using two interference cancellation components (passive isolator 320 and active interference canceller 325), transceiver 335 may include additional or fewer interference cancellation components. In some cases, one or more of the interference cancellation components may be functionally replaced by another interference cancellation component (not shown). For example, transceiver 335 may be configured so that different combinations of interference cancellation components may be used at different times or in different scenarios. Thus, transceiver 335 may be capable of providing various levels of interference mitigation on a dynamic basis.

Transceiver 335 may transmit and receive signals using antenna 310. In some cases, there may be multiple antennas 310. Transceiver 335 may send and receive signals simultaneously or at different times. If signals are transmitted and received simultaneously, they might interfere with one another. For example, self-interference may arise in which the transmitted signal interferes with the received signal. Interference may increase as transmitted and received signals become closer in frequency. In a full duplex system in which signals are sent and received simultaneously over the same frequency, interference may significantly contribute to the degradation of signal integrity. In order to reduce interference between signals, transceiver 335 may use a combination of interference cancellers (e.g., the passive isolator 320 and active interference canceller 325).

Transceiver 335 may include a transmitter 305. The transmitter 305 may generate signals for transmission over the air by antenna 310. In some scenarios, signals generated by the transmitter 305 are passed to the passive isolator 320. The passive isolator 320 may provide isolation between the transmit and receive paths associated with transmitter 305 and the receiver 330 while allowing simultaneous use of shared antenna 310. In some cases, (e.g., when the transmit and receive signals are on adjacent bands) the passive isolator 320 is a duplexer that separates transmit and receive signals by using frequency-selective filters. A duplexer may additionally or alternatively filter out noise side-bands from the transmitter 305 that are being generated on the receive frequency. In certain examples, the passive isolator 320 is a circulator which directs transmission signals from transmitter 305 to antenna 310 and directs receive signals from antenna 310 to receiver 330. A circulator may be a non-reciprocal ferrite device with three or more ports. Power entering one port of a circulator is transmitted to the next port in a rotation pattern (e.g., clockwise). A circulator may protect the transmitter 305 from impedance mismatch by the antenna 310. In yet other examples, the passive isolator 320 is a hybrid transformer (e.g., a broadband hybrid transformer) that provides transmit and receive path isolation. The types of passive isolator components described herein are non-limiting examples—the techniques described herein may be implemented using various types of passive isolators known in the art.

In some cases, transceiver 335 may include a tuning circuit 315. Tuning circuit may provide impedance matching. For example, the tuning circuit 315 may increase the power delivered to the antenna 310 by matching the antenna impedance to the impedance of the transmission line (not shown) used to deliver transmit signals. Additionally or alternatively, the tuning circuit 315 may provide matching between the passive isolator 320 and the antenna 310.

In addition to the passive isolator 320, transceiver 335 may include an active interference canceller 325 that provides interference mitigation. By using both passive isolator 320 and active interference canceller 325, transceiver 335 may boost its cancellation gain by aggregating the isolation and cancellation effects of each component. The active interference canceller 325 may be an active filter. For example, the active interference canceller may be a film-bulk acoustic resonator (FBAR) filter or surface acoustic wave (SAW) filter that removes unwanted frequencies while allowing other frequencies to be received and transmitted. In other configurations of transceiver 335, the active interference canceller 325 may be a feed-forward power amplifier (FFPA).

Transceiver 335 may, in some cases, include a logical block (e.g., an interference cancellation manager) (not shown) that computes the cancellation requirements for the wireless device in which the transceiver 335 resides. The logical block may also compute the power expenditure for interference cancellation that the wireless device is capable of affording (i.e., the logical block may calculate the power margin). As described above, the transceiver 335 may include several interference cancellation components, each of which may be combined with other interference cancellation components to provide an overall aggregated gain. Each combination of interference cancellers may provide a distinct level of interference mitigation and have an associated cost (e.g., power expenditure). Accordingly, the logical block may compute the expected cost and expected cancellation for each combination and compare the results with the desired interference mitigation and acceptable power consumption. The logical block may select the combination of analog RF interference cancellers that satisfies the cancellation and power requirements at the lowest cost. In some cases, the selected combination is the configuration of components shown in FIG. 3. However, alternative combinations may be selected.

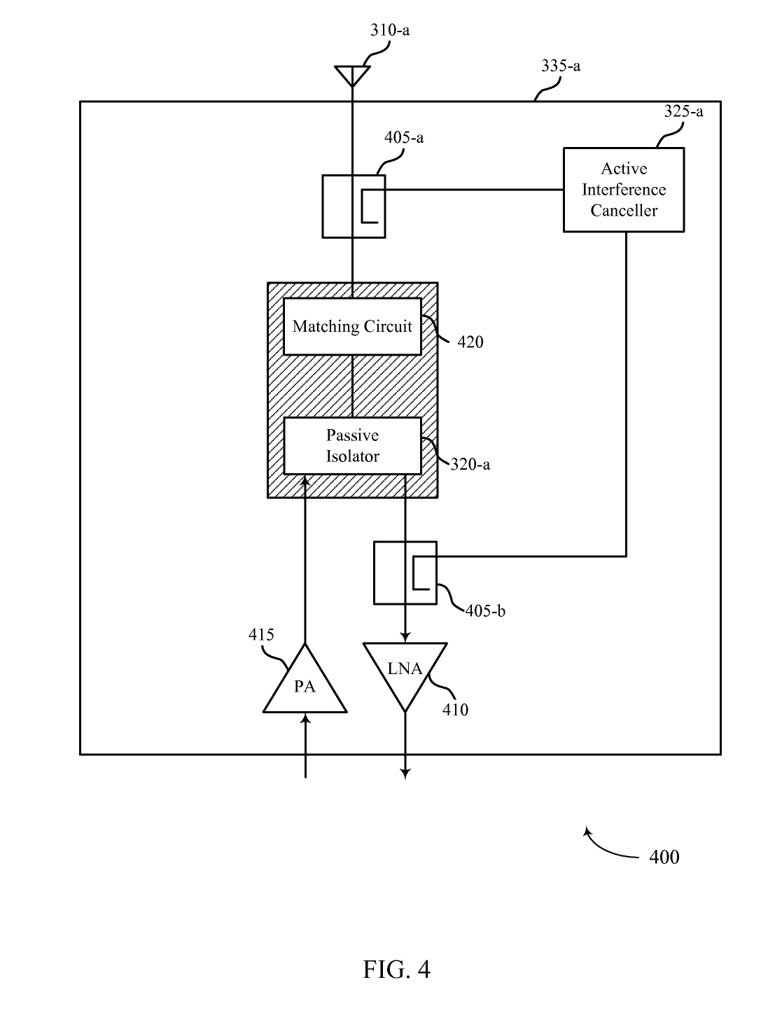

For example, FIG. 4 shows a block diagram of an interference cancellation configuration 400 for dynamic selection of analog interference cancellers in accordance with various aspects of the present disclosure. Interference cancellation configuration 400 may include transceiver 335-a, which may be an example of aspects of transceiver 335 described with reference to FIG. 3. For instance, transceiver 335-a may show one example of an RF interference canceller combination that may be dynamically implemented and used by the transceiver 335.

Transceiver 335-a may, like transceiver 335, include a number of RF interference cancellation components that are candidates for use in a dynamic aggregated interference mitigation scheme. Transceiver 335-a may be included a UE 115, AP 110, or base station 105 such as described in FIGS. 1 and 2. Accordingly, signals may be simultaneously transmitted and received over antenna 310-a. Power amplifier (PA) 415 may be used to amplify (e.g., power-boost) transmit signals prior to transmission over the air. Similarly, low-noise amplifier (LNA) 410 may be used to amplify received signals (e.g., those received by the antenna 310-a) prior to signal processing.

Although transceiver 335-a may include other interference cancellers, interference cancellation configuration 400 includes an active interference canceller 325-a combined with a passive isolator 320-a and associated matching circuit 420. The passive isolator 320-a may be any of the passive isolators described with reference to FIG. 2. Matching circuit 420 may provide impedance matching and may be an example of tuning circuit 315. The active interference canceller 325-a may be an example of an active receiver noise canceller. In some case, the active interference canceller 325-a may be used to inject cancellation signals for interference mitigation. For example, the active interference canceller 325-a may be used to inject cancellation signals into the receive path of transceiver 335-a. The injection signal may serve to counter-act signal distortion caused by interference (e.g., from a transmit signal) by reversing the effects of the interference. In order to provide different rejection signals for different directions, active interference canceller 325-a may be used in conjunction with directional couplers 405-a and 405-b. By using the active interference canceller 325-a, the transceiver 335-a may enjoy separation between receive and transmit signals even when the signals are in the same frequency. Thus, active interference canceller 325-a may be used by transceiver 335-a to provide interference cancellation (e.g., gain). The passive isolator 320-a may also be used to provide gain. Accordingly, transceiver 335-a may realize a cumulative gain that is the aggregation of the gain provided by the active interference canceller 325-a and the passive isolator 320-a.

As previously mentioned, the transceiver 335-a may include a number of additional RF analog interference cancellers that are available for use. The transceiver 335-a may select which interference cancellers to use based on benefits (e.g., gain) and costs (e.g., power consumption) associated with each component and/or combination of components. For example, there may be a mismatch between discrete components and the response of the passive isolator 320-a is sensitive to proper impedance tuning, which may result is sub-optimal performance. The active interference canceller 325-a may also have associated costs—for example, the active interference canceller 325-a may consume current (e.g., 30 mA). One benefit of interference cancellation configuration 400 is that the transceiver 335-a may inject a cancellation signal without a matching filter.

Transceiver 335-a may elect to activate (e.g., use) certain cancellers whose combination gain and costs are appropriate with the operating context of the wireless device. For example, transceiver 335-a may include or be in communication with a logical block (e.g., an interference cancellation manager) that selects a combination of interference cancellers that provide a target interference cancellation (e.g., desired gain) at an acceptable cost (e.g., target power consumption). The logical block may determine the desired gain based on conditions indicative of interference (e.g., errors in the received signal, bit-error-rate (BER), etc.). In some cases, the target interference cancellation may be based at least in part on the priority of the radio associated with the transceiver (e.g., high priority radios may be assigned higher interference cancellation targets than low priority radios). In other cases, the target interference cancellation may be based on the priority of the wireless device in which the transceiver 335-a is included.

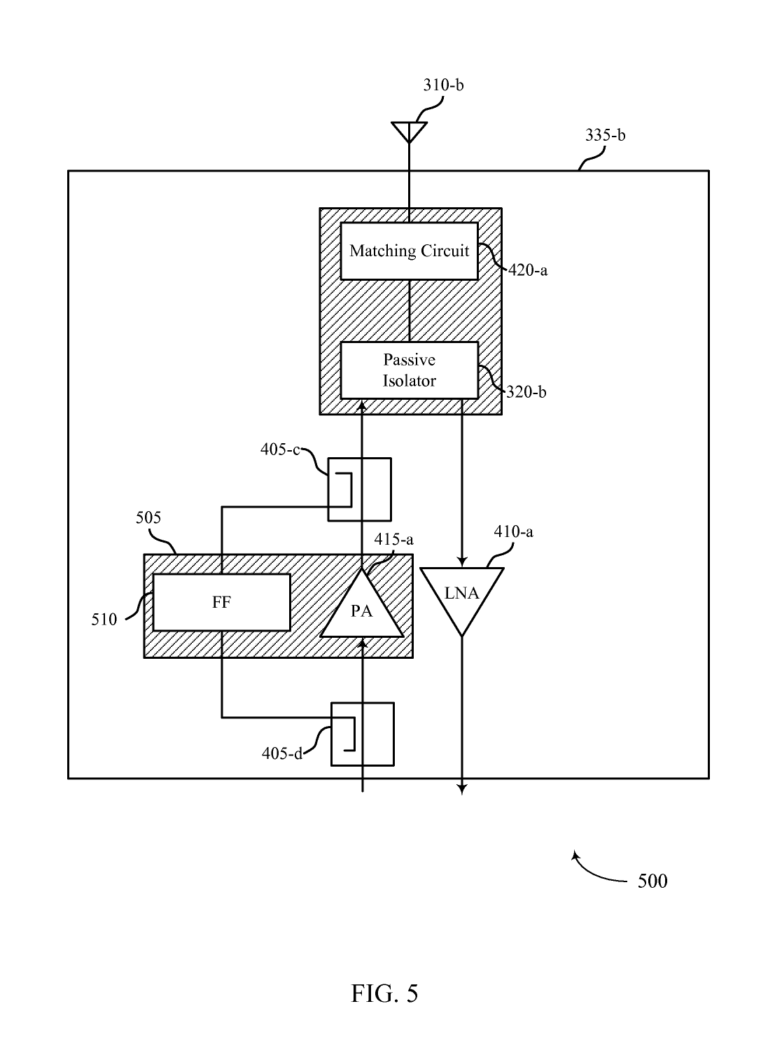

Interference cancellation configuration 400 shows one example of an analog interference canceller combination; however, other configurations of active and passive cancellation components may be used to provide an aggregated cancellation gain. An example of an alternative configuration is illustrated in FIG. 5, which shows a block diagram of an interference cancellation configuration 500 for dynamic selection of analog interference cancellers in accordance with various aspects of the present disclosure. Interference cancellation configuration 500 may include transceiver 335-b, which may include antenna 310-b, passive isolator 320-b, matching circuit 420-a, and LNA 410-a, each of which may perform the functions described with reference to FIGS. 3 and 4. Instead of using the combination of components shown in active interference canceller 325-a, transceiver 335-b may achieve aggregated gain by combining the passive isolator 320-b with the feed-forward power amplifier (FFPA) 505. The FFPA 505 may be an example of an active transmitter noise canceller, and may include a feed-forward control 510 and a PA 415-a. The FFPA 505 may be an adaptive feed-forward power amplifier that power-boosts transmit signals while introducing negligible amounts of distortion. The FFPA 505 may be used in conjunction with direction coupler 405-a and directional coupler 405-d. In some cases, the FFPA 505 may pre-cancel out-of-band (00B) emission at the transmitter (not shown).

Like other RF analog interference cancellers, operation of the FFPA 505 may incur certain costs. For example, the FFPA 505 may provide high gain but at high levels of power consumption (e.g., current consumption may be 150 mA). Additionally, insertion loss may associated with the FFPA 505 may be high (e.g., three couplers 405 after PA 415-a). A logical block (e.g., an interference cancellation manager) may take these considerations into account when determining which components to select for use by transceiver 335-b. The logical block may also consider the benefits of each cancellation component (e.g., provided gain), as well as the benefits using certain cancellers together. For example, the combination of the passive isolator 320-b and the FFPA 505 does not introduce a component in the receive path (as opposed to the configuration shown in transceiver 335-a). And because there is no noise injection, there is no additional path loss. The logical block may evaluate some or all of these aspects when determining which combination to use.

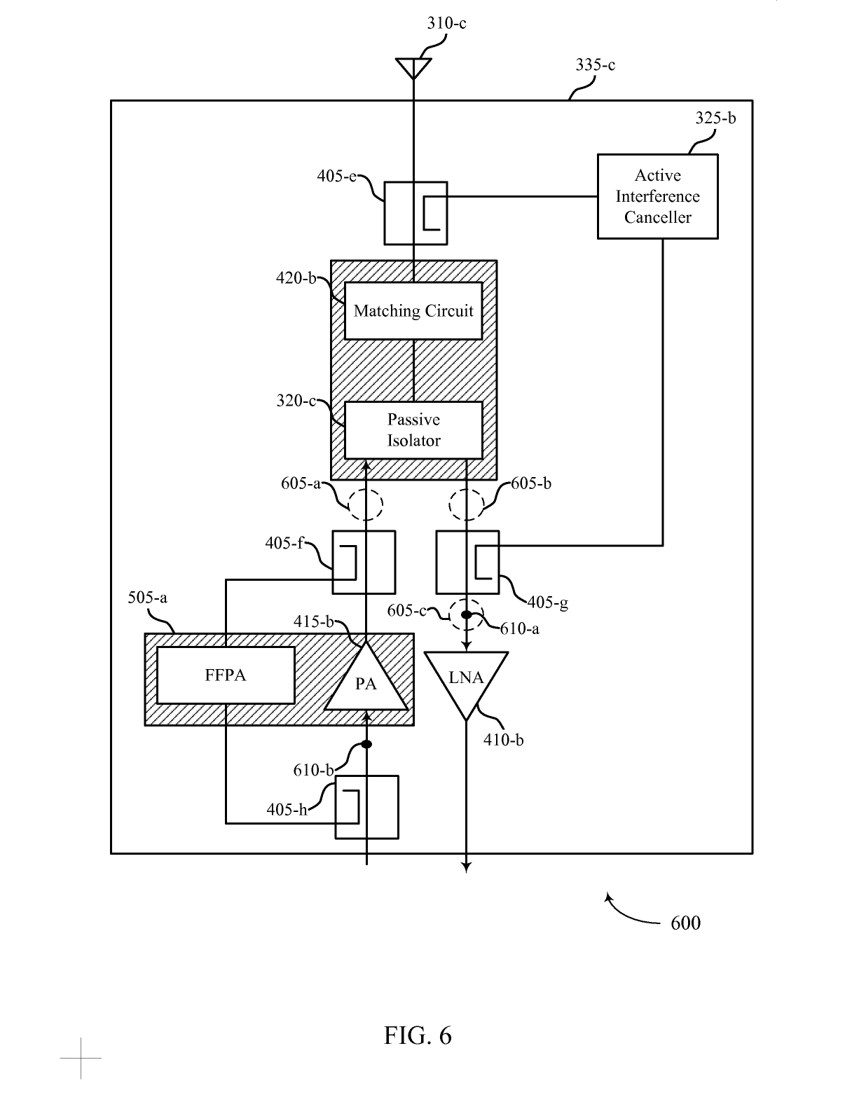

In one example, the logical block may consider two cancelation gain thresholds (a lower threshold and an upper threshold) that divide the cancellation needs into three categories—low, medium, and high. If the cancellation requirement does not meet or exceed the lower threshold, the cancellation need may be categorized as low. In such a scenario, the RF analog canceler combination shown in transceiver 335-a may be selected for use. If the cancellation requirement meets the lower threshold but does not meet or exceed the upper threshold, the cancellation need may be categorized as medium. In such cases, the RF analog canceler combination shown in transceiver 335-b may be selected for use. If the cancellation requirement meets or exceeds the upper threshold, the cancellation requirement may be categorized as high. In such a scenario, a combination of a FFPA, passive isolator, and active interference canceller may be selected for interference mitigation. Such a configuration is depicted in FIG. 6, which shows a block diagram of an interference cancellation configuration 600 for dynamic selection of analog interference cancellers in accordance with various aspects of the present disclosure. Interference cancellation configuration 600 may include transceiver 335-c, which may be an example of a transceiver 335 described with reference to FIGS. 3-5.

Transceiver 335-c may use a combination of the passive isolator 320-c, active interference canceller 325-b, and the FFPA 505-a to provide aggregated interference mitigation for signals transmitted over antenna 310-c. Transceiver may also include receive and transmit path components such as couplers 405-e, 405-f, 405-g, 405-h and LNA 410-b. In some cases, transceiver 335-c may also include passive transmit path cancellation components (e.g., passive filters such as notch and band-pass filters). In some examples, a passive transmit path cancellation component may be placed at cancellation sites 605-a, 605-b, or 605-c, or any place after the active interference canceller 325-b (e.g., after injection coupler 405-g). Thus, transceiver 335-c may use a combination of active receiver noise cancellation components, active transmitter noise cancellation components, and passive transmitter noise cancellation components.

The interference cancellation configuration 600 may be selected by a logical block such as described above. The selection may be based on satisfying an interference cancellation requirement and power consumption target. The power consumption target may be based on the priority of the associated radio or the priority of the wireless device. In other cases, the power consumption target may be based on a power margin for the associated radio (e.g., the difference between the power capabilities of the radio and the present power consumption). In some cases, the target interference cancellation or target power consumption may be determined based on signal power measurements taken at the transceiver 335-c. For example power measurements may be taken for signals at the measurement point 610-a (e.g., at the input of LNA 410-b) and/or at the measurement point 610-b (e.g., at the input of the PA 415-b). Such measurements may indicate the strength of the transmit and receive signals prior to amplification.

In other cases, the selection of RF analog interference cancellers may be based on the power consumption and interference cancellation that is estimated for each combination. The estimations for each combination may be computed for different transmit and receive frequencies (e.g., the estimations may different for different transmit/receive frequency separations). The estimations may be stored in a pre-defined lookup table which may be referenced by a logical block, or other computing component. In some examples, the target interference cancellation is compared to the estimated interference cancellation (e.g., gain) and the target power consumption is compared to the estimated power consumption for each combination. Based on the comparisons, a transceiver 335 may select for use the combination of interference cancellers that satisfies the target cancellation requirement without exceeding the power consumption limit.

Although described with reference to a single antenna 310, a transceiver 335 may include multiple antennas (e.g., for multiple-input-multiple-output (MIMO) or carrier aggregation (CA) communications). Each antenna may be correspond to one or more radios (e.g., an LTE radio or a WLAN radio). When a transceiver includes multiple antennas, the transmitter noise from one antenna may fall into another antenna. In such scenarios, the techniques described herein may be used to mitigate trans-antenna interference (i.e., interference between two antennas). That is, a combinations of RF analog interference cancellers may be dynamically selected for an antenna to overcome the interference cause by a disparate antenna. In some cases, the combination of cancellers may be different for different antennas. In this or other cases, one or more cancellers may be shared between antennas. In certain scenarios, an entire combination of interference cancellers may be shared between antennas. Although the same architecture (e.g., FFPA, passive isolator, and active interference canceller combination) may be used for different antennas on a transceiver 335, there may be different reference points for the active interference canceller.

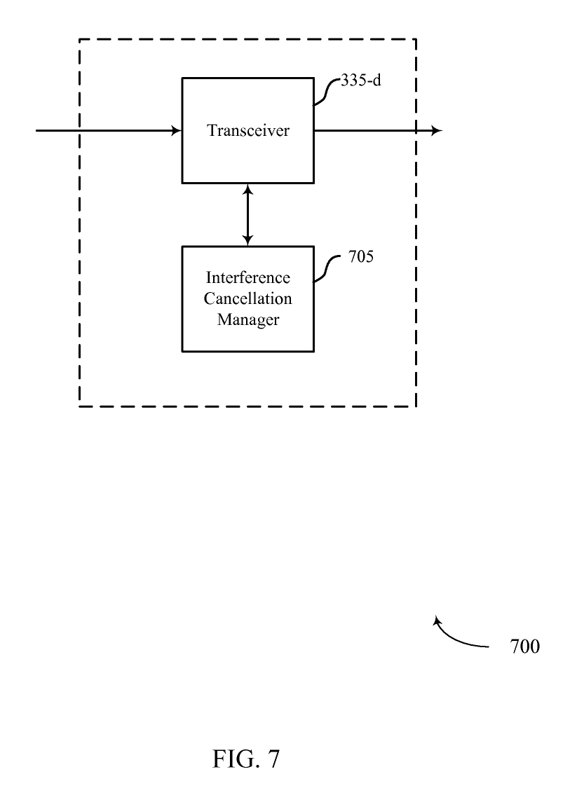

FIG. 7 shows a block diagram of a wireless device 700 that supports dynamic selection of analog interference cancellers in accordance with various aspects of the present disclosure. Wireless device 700 may be an example of aspects of a UE 115, base station 105, or AP 110 described with reference to FIGS. 1 and 2. Wireless device 700 may include a transceiver 335-d, which may be an example of a transceiver 335 described with reference to FIGS. 3-6. Wireless device 700 may also include an interference cancellation manager 705. In some cases, wireless device 700 may also include a processor. Each of these components may be in communication with each other.

The transceiver 335-d may receive information such as packets, user data, or control information associated with various information channels (e.g., control channels, data channels, and information related to dynamic selection of analog interference cancellers, etc.). Information may be passed on to the interference cancellation manager 705, and to other components of wireless device 700. The transceiver 335-d may also transmit signals received from other components of wireless device 700. In some cases, the transceiver 335-d receives and transmit signals at the same time (e.g., over one or more antennas (not shown)). In such cases, the transceiver 335-d may use a combination of interference cancellation components to provide adequate cancellation at appropriate power consumption levels. For instance, the transceiver may use one of the interference cancellation configurations described with reference to FIGS. 3-6. The interference cancellation configuration used by the transceiver 335-d may be adaptive (e.g., dynamically updated). That is, different combinations of analog interference cancellers may be used at different times, according to the needs of the wireless device 700.

The interference cancellation manager 705 may determine a target interference cancellation for the wireless device 700. In some cases, the interference cancellation manager 705 may also determine a target power consumption for the wireless device 700. The interference cancellation manager 705 may identify a number of analog interference cancellers available for use in the wireless device 700. Based on the target interference cancellation, the interference cancellation manager 705 may select a combination of the available analog interference cancellers for use at the transceiver 335-d of the wireless device 700. In some cases, the combination of analog interference cancellers is also based on the target power consumption.

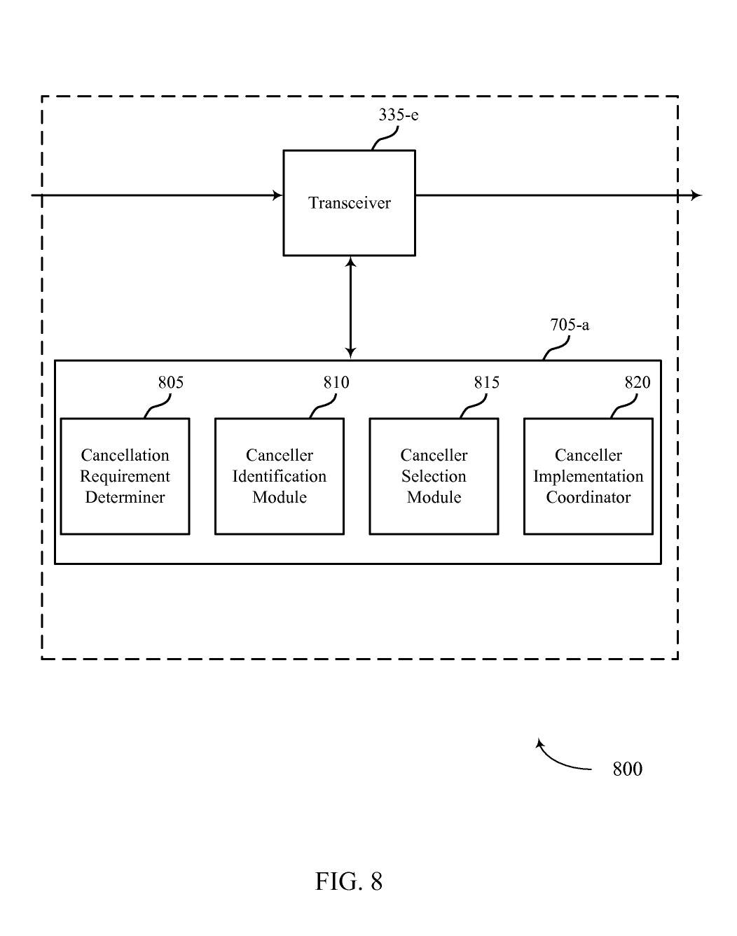

FIG. 8 shows a block diagram of a wireless device 800 that supports dynamic selection of analog interference cancellers in accordance with various aspects of the present disclosure. Wireless device 800 may be an example of aspects of a wireless device 700, UE 115, AP 110, or base station 115 described with reference to FIGS. 1-7. Wireless device 800 may include a transceiver 335-e and an interference cancellation manager 705-a. Wireless device 800 may also include a processor. Each of these components may be in communication with each other. The transceiver 335-e may be an example of a transceiver 335 described with reference to FIGS. 3-7. The interference cancellation manager 705-a may perform the operations described with reference to FIG. 7. The interference cancellation manager 705-a may include a cancellation requirement determiner 805, a canceller identification module 810, a canceller selection module 815, and a canceller implementation coordinator 820.

The cancellation requirement determiner 805 may determine for wireless device 800 a target interference cancellation as described with reference to FIGS. 2-6. The cancellation requirement determiner may also determine a target power consumption as described with reference to FIGS. 2-6. In some cases, the cancellation requirement determiner 805 may measure a signal power at the transceiver. In such instances, the determination of the target interference cancellation is based at least in part on the measured signal power. In some examples, the cancellation requirement determiner 805 may identify a power margin for the wireless device. Accordingly, the cancellation requirement determiner 805 may determine the target power consumption based at least in part on the identified power margin. In certain cases, the cancellation requirement determiner 805 may identify a priority associated with the wireless device 800 (e.g., the priority of a radio in the wireless device 800). In such cases, the determination of the target interference cancellation (or the target power consumption) may be based on the identified priority. The cancellation requirement determiner 805 may communicate the target interference cancellation and/or target power consumption to other components in the wireless device 800, or interference cancellation manager 705-a.

In some examples, the cancellation requirement determiner 805 may compare the target interference cancellation to one or more thresholds (e.g., a lower threshold and an upper threshold). Thus, the cancellation requirement determiner 805 may, in some cases, determine that the target interference cancellation is below or equal to a threshold (e.g., the lower threshold). In other cases, the cancellation requirement determiner 805 may determine that the target interference cancellation is equal to or between a first threshold and a second threshold. Or the cancellation requirement determiner 805 may determine that the target interference cancellation is greater than or equal to a threshold (e.g., the upper threshold). Although two thresholds are described, the cancellation requirement determiner 805 may compare the target interference cancellation to any number of thresholds. The cancellation requirement determiner 805 may communicate the results of the comparison(s) to other components in the wireless device 800, or interference cancellation manager 705-a.

The canceller identification module 810 may identify the analog interference cancellers available for use in the wireless device 800 as described with reference to FIGS. 2-6. For example, the canceller identification module 810 may identify passive analog interference cancellers such as passive filters (e.g., notch and band-pass filters), duplexers, hybrid transformers, circulators, etc. The canceller identification module 810 may also identify active analog interference cancellers such as active filters (e.g., SAW or FBAR filters) or FFPAs. In some cases, the canceller identification module 810 may also detect the number of antennas at the transceiver.

The canceller selection module 815 may select a combination of the available analog interference cancellers for use at the transceiver 335-e. The selection of cancellation components may be based at least in part on the target interference cancellation or the target power consumption as described with reference to FIGS. 2-6. In some examples, the canceller selection module 815 selects passive analog interference cancellers and active analog interference cancellers for the combination. In one example, the selected combination includes a passive isolator and an active interference canceller. In another example, the selected combination includes a passive isolator and a feed-forward power amplifier (FFPA). In yet another example, the selected combination to include a passive isolator, a feed-forward power amplifier (FFPA), and an active interference canceller. In some examples, the combination of analog interference cancellers includes a passive isolator (e.g., a duplexer or hybrid transformer), an active receiver noise canceller (e.g., an active interference canceller), and a passive transmitter noise canceller (e.g., a notch or band-pass filter). In some examples, the combination of analog interference cancellers includes a passive isolator (e.g., a duplexer or hybrid transformer), an active receiver noise canceller (e.g., an active interference canceller), and an active transmitter noise canceller (e.g., an FFPA). In some examples, this combination further includes a passive transmitter noise canceller (e.g., a notch or band-pass filter). In some cases, the combination of analog interference cancellers includes a passive isolator, an associated tuning circuit, and an active analog interference canceller.

In certain scenarios, the canceller selection module 815 may access a look-up table that stores estimations of interference cancellation for various combinations of interference cancellers. The look-up table may also include estimations of power consumption corresponding to each combination. Accordingly, the selection of analog interference cancellers by the canceller selection module 815 may be based at least in part on the estimate interference cancellation and/or the estimated power consumption for the combinations. For example, the canceller selection module 815 may compare the target interference cancellation to the interference cancelation estimations for the analog interference canceller combinations and select the combination that provides the required interference mitigation. In some cases, the canceller selection module 815 may also compare the target power consumption to the power consumption estimations for the analog interference cancellers combinations and select the combination that satisfies the target interference requirement and does not exceed the power consumption target.

In certain examples, the wireless device 800 may include multiple antennas. In such instances, the canceller selection module 815 may select analog interference canceller combinations for each antenna. For example, the canceller selection module 815 may select a distinct combination of analog interference cancellers for each antenna. In this scenario, the interference cancellation configuration for an antenna may share one or more components with an interference cancellation configuration for another antenna. In other cases, several antennas may share the same interference cancellation configuration.

Once the combination of analog interference cancellers has been selected, the canceller implementation coordinator 820 may facilitate the use of the combination in the transceiver 335-e of the wireless device 800 as described with reference to FIGS. 2-6. For example, the canceller implementation coordinator 820 may instigate a change in the interference cancellation configuration used by the transceiver 335-e by facilitating a change in component connections.

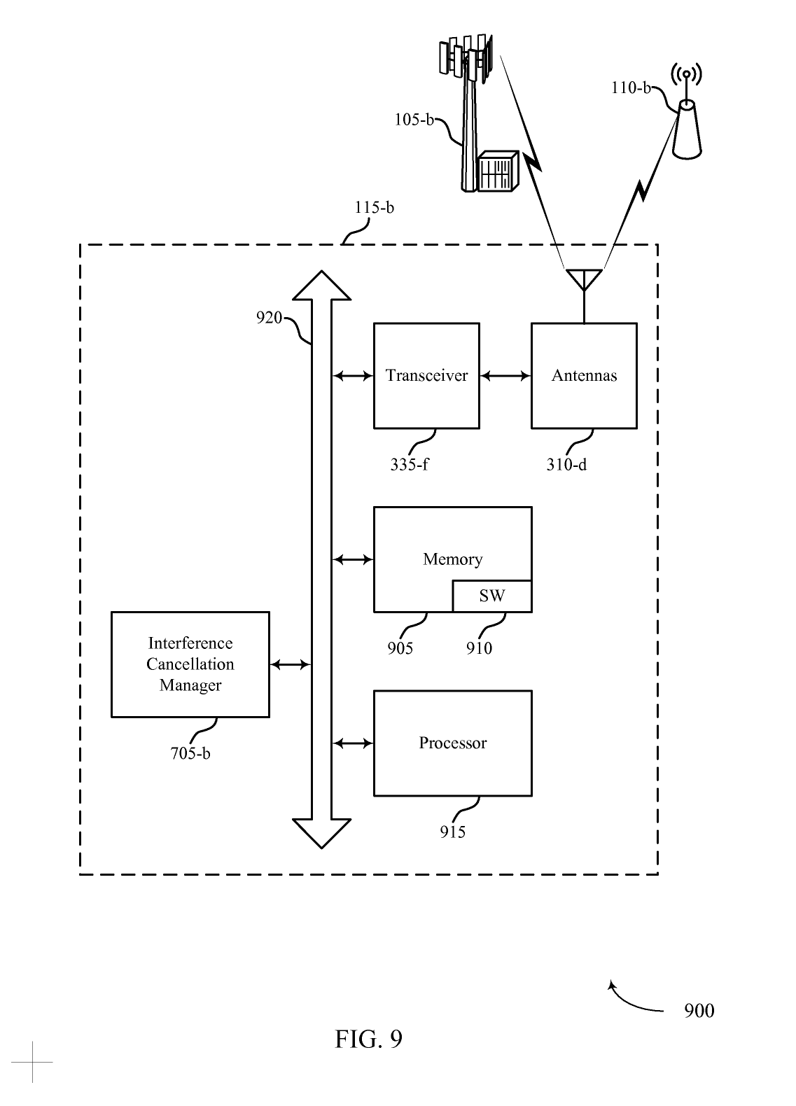

FIG. 9 shows a diagram of a system 900 including UE 115-b configured for dynamic selection of analog interference cancellers in accordance with various aspects of the present disclosure. UE 115-b may be an example of a wireless device 700, a wireless device 800, or a UE 115 described with reference to FIGS. 1, 2, 7, and 8. UE 115-b may include an interference cancellation manager 705-b, which may be an example of an interference cancellation manager 705 described with reference to FIGS. 7 and 8. UE 115-b may also include components for bi-directional voice and data communications including components for transmitting communications and components for receiving communications. For example, UE 115-b may communicate bi-directionally with base station 105-b or AP 110-b. In some cases, UE 115-b may communicate with base station 105-b and AP 110-b at the same time (e.g., over the same or different antennas).

UE 115-b may also include a processor 915, and memory 905 (including software (SW) 910), a transceiver 335-f, and one or more antenna(s) 310-d, each of which may communicate, directly or indirectly, with one another (e.g., via buses 920). The transceiver 335-f may be an example of a transceiver 335 described with reference to FIGS. 3-6. Thus, the transceiver 335-f may be capable of dynamically switching between interference cancellation configurations. The transceiver 335-f may communicate bi-directionally, via the antenna(s) 310-d or wired or wireless links, with one or more networks, as described above. For example, the transceiver 335-f may communicate bi-directionally with a base station 105, AP 110, or another UE 115. In some cases, the transceiver 335-f may transmit and receive signals simultaneously. The transceiver 335-f may include a modem to modulate the packets and provide the modulated packets to the antenna(s) 310-d for transmission, and to demodulate packets received from the antenna(s) 310. While UE 115-b may include a single antenna 310-d, UE 115-b may also have multiple antennas 310-d capable of concurrently transmitting or receiving multiple wireless transmissions.

The memory 905 may include random access memory (RAM) and read only memory (ROM). The memory 905 may store computer-readable, computer-executable software/firmware code 1020 including instructions that, when executed, cause the processor 915 to perform various functions described herein (e.g., dynamic selection of analog interference cancellers, etc.). Alternatively, the software/firmware code 905 may not be directly executable by the processor 915 but cause a computer (e.g., when compiled and executed) to perform functions described herein. The processor 915 may include an intelligent hardware device, (e.g., a central processing unit (CPU), a microcontroller, an application specific integrated circuit (ASIC), etc.).

The components of wireless device 700, wireless device 800, and the interference cancellation manager 705 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

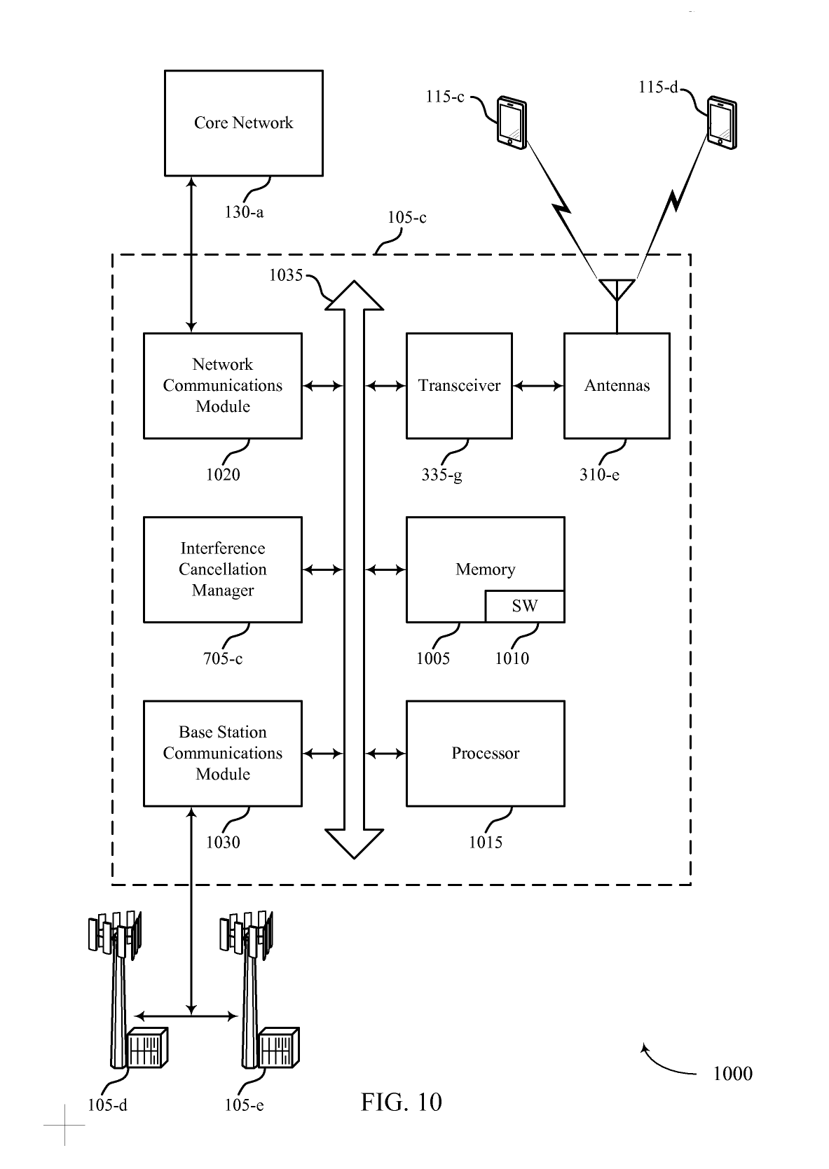

FIG. 10 shows a diagram of a system 1000 including a base station 105-c configured for dynamic selection of analog interference cancellers in accordance with various aspects of the present disclosure. Base station 105-c, which may be an example of a wireless device 800, a wireless device 900, a base station 105, or an AP 110 described with reference to FIGS. 1, 2, 8 and 9. Base station 105-c may include an interference cancellation manager 705-c, which may be an example of a base station interference cancellation manager 705 described with reference to FIGS. 7 and 8. Base station 105-b may also include components for bi-directional voice and data communications including components for transmitting communications and components for receiving communications. For example, base station 105-b may communicate bi-directionally with UE 115-c or UE 115-d.

In some cases, base station 105-b may have one or more wired backhaul links. Base station 105-c may have a wired backhaul link (e.g., S1 interface, etc.) to the core network 130-a. Base station 105-c may also communicate with other base stations 105, such as base station 105-d and base station 105-e via inter-base station backhaul links (e.g., an X2 interface). Each of the base stations 105 may communicate with UEs 115 using the same or different wireless communications technologies. In some cases, base station 105-c may communicate with other base stations such as 105-d or 105-e utilizing base station communications module 1030. In some examples, base station communications module 1030 may provide an X2 interface within a Long Term Evolution (LTE)/LTE-A wireless communication network technology to provide communication between some of the base stations 105. In some examples, base station 105-c may communicate with other base stations through core network 130-a. In some cases, base station 105-c may communicate with the core network 130-c through network communications module 1020.

The base station 105-c may include a processor 1015, memory 1005 (including software (SW) 1010), transceiver 335-g, and antenna(s) 310-e, which each may be in communication, directly or indirectly, with one another (e.g., over bus system 1035). The transceiver may be an example of a transceiver 335 described with reference to FIGS. 3-8, and may perform the functions described therein. The transceiver 335-g may be configured to communicate bi-directionally, via the antenna(s) 310-e, with the UEs 115, which may be multi-mode devices. The transceiver 335-g (or other components of the base station 105-c) may also be configured to communicate bi-directionally, via the antennas 310-e, with one or more other base stations. The transceiver 335-g may include a modem configured to modulate the packets and provide the modulated packets to the antennas 310-e for transmission, and to demodulate packets received from the antennas 310-e. The base station 105-c may include multiple transceivers 335-g, each with one or more associated antennas 310-e.

The memory 1005 may include RAM and ROM. The memory 1005 may also store computer-readable, computer-executable software code 1010 containing instructions that are configured to, when executed, cause the processor 1015 to perform various functions described herein (e.g., dynamic selection of analog interference cancellers, selecting coverage enhancement techniques, call processing, database management, message routing, etc.). Alternatively, the software 1010 may not be directly executable by the processor 1015 but be configured to cause the computer (e.g., when compiled and executed) to perform functions described herein. The processor 1015 may include an intelligent hardware device (e.g., a CPU, a microcontroller, an ASIC, etc.). The processor 1015 may include various special purpose processors such as encoders, queue processing modules, base band processors, radio head controllers, digital signal processor (DSPs), and the like.

The base station communications module 1030 may manage communications with other base stations 105. In some cases, a communications management module may include a controller or scheduler for controlling communications with UEs 115 in cooperation with other base stations 105. For example, the base station communications module 1030 may coordinate scheduling for transmissions to UEs 115 for various interference mitigation techniques such as beamforming or joint transmission.

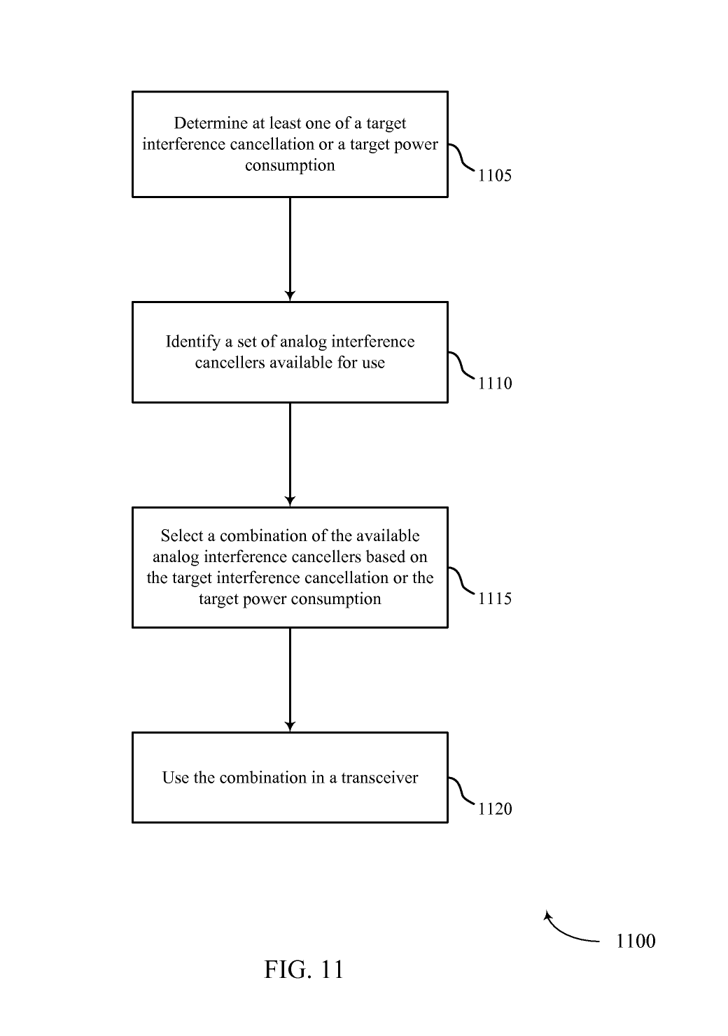

FIG. 11 shows a flowchart illustrating a method 1100 for dynamic selection of analog interference cancellers in accordance with various aspects of the present disclosure. The operations of method 1100 may be implemented by a UE 115, base station 105, AP 110, or corresponding components as described with reference to FIGS. 1-10. For example, the operations of method 1100 may be performed by the interference cancellation manager 705 as described with reference to FIGS. 7-10. In some examples, a UE 115 may execute a set of codes to control the functional elements of the UE 115 to perform the functions described below. Additionally or alternatively, the UE 115 may perform aspects the functions described below using special-purpose hardware.

At block 1105, the UE 115 may determine for itself at least one of a target interference cancellation or a target power consumption as described with reference to FIGS. 2-6. In certain examples, the operations of block 1105 may be performed by the cancellation requirement determiner 805 as described with reference to FIG. 8. Proceeding to block 1110, the UE 115 may identify a plurality of analog interference cancellers available for use as described with reference to FIGS. 2-6. In certain examples, the operations of block 1110 may be performed by the canceller identification module 810 as described with reference to FIG. 8. At block 1115, the UE 115 may select a combination of the available analog interference cancellers based at least in part on the target interference cancellation or the target power consumption as described with reference to FIGS. 2-6. In certain examples, the operations of block 1215 may be performed by the canceller selection module 815 as described with reference to FIG. 8. At block 1120, the UE 115 may use the selected combination of analog interference cancelers in a transceiver as described with reference to FIGS. 2-6. In certain examples, the operations of block 1120 may be performed by the canceller implementation coordinator 820 as described with reference to FIG. 8.

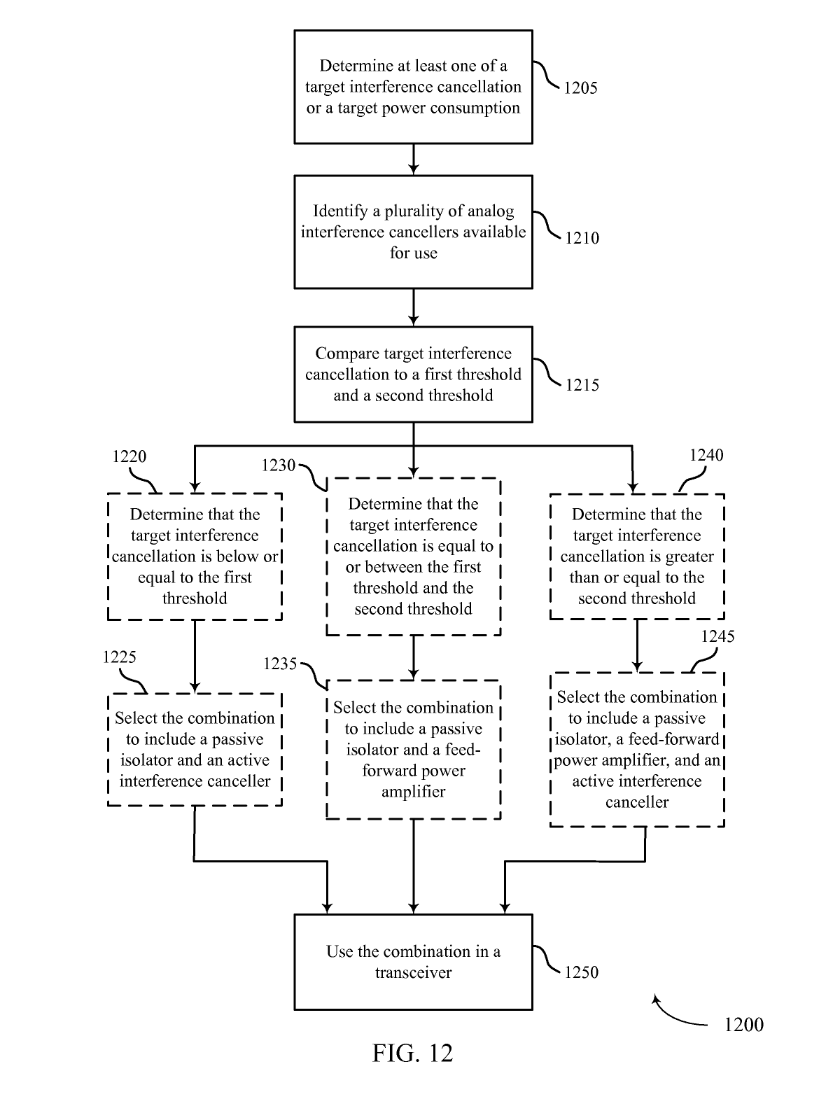

FIG. 12 shows a flowchart illustrating a method 1200 for dynamic selection of analog interference cancellers in accordance with various aspects of the present disclosure. The operations of method 1200 may be implemented by a UE 115, base station 105, AP 110, or corresponding components as described with reference to FIGS. 1-10. For example, the operations of method 1200 may be performed by the interference cancellation manager 705 as described with reference to FIGS. 7 and 8. In some examples, a UE 115 may execute a set of codes to control the functional elements of the UE 115 to perform the functions described below. Additionally or alternatively, the UE 115 may perform aspects the functions described below using special-purpose hardware. The method 1200 may also incorporate aspects of method 1100 of FIG. 11.

At block 1205, the UE 115 may determine at least one of a target interference cancellation or a target power consumption as described with reference to FIGS. 2-6. In certain examples, the operations of block 1205 may be performed by the cancellation requirement determiner 805 as described with reference to FIG. 8. At block 1210, the UE 115 may identify a plurality of analog interference cancellers available for use in the wireless device as described with reference to FIGS. 2-6. In certain examples, the operations of block 1210 may be performed by the canceller identification module 810 as described with reference to FIG. 8. Proceeding to block 1215, the UE 115 may compare the target interference cancellation to a first threshold (e.g., a lower threshold) and a second threshold (e.g., an upper threshold).

Based on the comparison, at block 1220 the UE 115 may determine that the target interference cancellation is below or equal to the first threshold. Accordingly, at block 1225, the UE 115 may select the combination of analog interference cancellers to include a passive isolator and an active interference canceller. In some cases, the UE 115 may determine at block 1230 that the target interference cancellation is equal to or between the first threshold and the second threshold. In such a scenario, the UE 115 may, at block 1235, select the combination of analog interference cancellers to include a passive isolator and a feed-forward power amplifier. In other examples, the UE 115 may, at block 1240, determine that the target interference cancellation is greater than or equal to the second threshold. Accordingly, at block 1245 the UE 115 may select the combination to include a passive isolator, a feed-forward power amplifier, and an active interference canceller. In certain examples, the operations of blocks 1215-1245 may be performed by the canceller selection module 815 as described with reference to FIG. 8.

At block 1250, the UE 115 may use the selected combination of analog interference cancellers in a transceiver as described with reference to FIGS. 2-6. In certain examples, the operations of block 1250 may be performed by the canceller implementation coordinator 820 as described with reference to FIG. 8.

Thus, methods 1100 and 1200 may provide for dynamic selection of analog interference cancellers. It should be noted that methods 1100 and 1200 describe possible implementation, and that the operations and the steps may be rearranged or otherwise modified such that other implementations are possible. In some examples, aspects from two or more of the methods 1100 and 1200 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-advanced (LTE-a) are new releases of Universal Mobile Telecommunications System (UMTS) that use E-UTRA. UTRA, E-UTRA, Universal Mobile Telecommunications System (UMTS), LTE, LTE-a, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-a networks, including such networks described herein, the term evolved node B (eNB) may be generally used to describe the base stations. The wireless communications system or systems described herein may include a heterogeneous LTE/LTE-a network in which different types of evolved node B (eNBs) provide coverage for various geographical regions. For example, each eNB or base station may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for frequency division duplex (FDD) (e.g., frame structure type 1) and TDD (e.g., frame structure type 2).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
determining, for a wireless device, at least one of a target interference cancellation or a target power consumption;
identifying a plurality of analog interference cancellers available for use in the wireless device;
selecting a combination of the available analog interference cancellers based at least in part on the target interference cancellation or the target power consumption; and
using the combination in a transceiver of the wireless device.

2. The method of claim 1, wherein selecting the combination of analog interference cancellers comprises:
selecting the combination to include one or more passive analog interference cancellers and one or more active analog interference cancellers.

3. The method of claim 1, further comprising:
determining that the target interference cancellation is below or equal to a threshold; and
wherein selecting the combination of analog interference cancellers comprises:
selecting the combination to include a passive isolator and an active interference canceller.

4. The method of claim 1, further comprising:
determining that the target interference cancellation is equal to or between a first threshold and a second threshold; and
wherein selecting the combination of analog interference cancellers comprises:
selecting the combination to include a passive isolator and a feed-forward power amplifier (FFPA).

5. The method of claim 1, further comprising:
determining that the target interference cancellation is greater than or equal to a threshold; and
wherein selecting the combination of analog interference cancellers comprises:
selecting the combination to include a passive isolator, a feed-forward power amplifier, and an active interference canceller.

6. The method of claim 1, further comprising:
measuring a signal power at the transceiver, wherein the determination of the target interference cancellation is based at least in part on the measurement.

7. The method of claim 1, further comprising:
accessing a look-up table, the look-up table indicating one or more of an estimated power consumption and interference cancellation for possible combinations of analog interference cancellers; and
selecting the combination of analog interference cancellers is based at least in part on the one or more estimated power consumption and interference cancellation for the possible combinations.

8. The method of claim 7, further comprising:
comparing at least one of the target interference cancellation or the target power consumption to corresponding estimations for each combination of analog interference cancellers; and
selecting the combination of analog interference cancellers is based at least in part on the comparison.

9. The method of claim 1, further comprising:
identifying a power margin for the wireless device; and
determining the target power consumption is based at least in part on the identified power margin.

10. The method of claim 1, further comprising:
identifying a priority associated with the wireless device; and
determining the at least one of the target interference cancellation or the target power consumption is based at least in part on the identified priority.

11. The method of claim 1, wherein selecting the combination of analog interference cancellers comprises:
active receiver noise canceller, or a passive transmitter noise canceller.

12. The method of claim 1, wherein selecting the combination of analog interference cancellers comprises:
selecting the combination to include one or more of a passive isolator, an active receiver noise canceller, or an active transmitter noise canceller.

13. The method of claim 1, wherein the plurality of analog interference cancellers comprises one or more passive analog interference cancellers which include one or more of a passive filter, a duplexer, a hybrid transformer, or a circulator.

14. The method of claim 1, wherein the plurality of analog interference cancellers comprises one or more active analog interference cancellers which include one or more of an active filter or a feed-forward power amplifier.

15. The method of claim 1, wherein selecting the combination of analog interference cancellers comprises:
selecting the combination to include a passive isolator, an associated tuning circuit, and an active analog interference canceller.

16. The method of claim 1, further comprising:
detecting a plurality of antennas at the transceiver; and
wherein selecting the combination of analog interference cancellers comprises:
selecting a combination of analog interference cancellers for each antenna of the plurality of antennas.

17. The method of claim 1, further comprising:
detecting a plurality of antennas at the transceiver; and
sharing one or more analog interference cancellers of the selected combination between two or more antennas of the plurality of antennas.

18. An apparatus for wireless communication, comprising:
means for determining, for a wireless device, at least one of a target interference cancellation or a target power consumption;
means for identifying a plurality of analog interference cancellers available for use in the wireless device;
means for selecting a combination of the available analog interference cancellers based at least in part on the target interference cancellation or the target power consumption; and
means for using the combination in a transceiver of the wireless device.

19. The apparatus of claim 18, wherein selecting the combination of analog interference cancellers comprises:
selecting the combination to include one or more passive analog interference cancellers and one or more active analog interference cancellers.

20. The apparatus of claim 18, further comprising:
means for determining that the target interference cancellation is below or equal to a threshold; and
wherein selecting the combination of analog interference cancellers comprises:
selecting the combination to include a passive isolator and an active interference canceller.

21. The apparatus of claim 18, further comprising:
means for determining that the target interference cancellation is equal to or between a first threshold and a second threshold; and
wherein selecting the combination of analog interference cancellers comprises:
selecting the combination to include a passive isolator and a feed-forward power amplifier.

22. The apparatus of claim 18, further comprising:
means for determining that the target interference cancellation is greater than or equal to a threshold; and
wherein selecting the combination of analog interference cancellers comprises:
selecting the combination to include a passive isolator, a feed-forward power amplifier, and an active interference canceller.

23. An apparatus for wireless communication, comprising:
a processor;
memory in electronic communication with the processor; and
instructions stored in the memory and operable, when executed by the processor, to cause the apparatus to:
determine, for a wireless device, at least one of a target interference cancellation or a target power consumption;
identify a plurality of analog interference cancellers available for use in the wireless device;
select a combination of the available analog interference cancellers based at least in part on the target interference cancellation or the target power consumption; and
use the combination in a transceiver of the wireless device.

24. The apparatus of claim 23, wherein the instructions are operable to cause the apparatus to:
determine that the target interference cancellation is below or equal to a threshold; and
wherein selecting the combination of analog interference cancellers comprises:
selecting the combination to include a passive isolator and an active interference canceller.

25. The apparatus of claim 23, wherein the instructions are operable to cause the apparatus to:
determine that the target interference cancellation is equal to or between a first threshold and a second threshold; and
wherein selecting the combination of analog interference cancellers comprises:
selecting the combination to include a passive isolator and a feed-forward power amplifier.

26. The apparatus of claim 23, wherein the instructions are operable to cause the apparatus to:
determine that the target interference cancellation is greater than or equal to a threshold; and
wherein selecting the combination of analog interference cancellers comprises:
selecting the combination to include a passive isolator, a feed-forward power amplifier, and an active interference canceller.

27. A non-transitory computer-readable medium storing code for wireless communication, the code comprising instructions executable to:
determine, for a wireless device, at least one of a target interference cancellation or a target power consumption;
identify a plurality of analog interference cancellers available for use in the wireless device;
select a combination of the available analog interference cancellers based at least in part on the target interference cancellation or the target power consumption; and
use the combination in a transceiver of the wireless device.

28. The non-transitory computer-readable medium of claim 27, wherein the instructions are executable to:
determine that the target interference cancellation is below or equal to a threshold; and
wherein selecting the combination of analog interference cancellers comprises:
selecting the combination to include a passive isolator and an active interference canceller.

29. The non-transitory computer-readable medium of claim 27, wherein the instructions are executable to:
determine that the target interference cancellation is equal to or between a first threshold and a second threshold; and
wherein selecting the combination of analog interference cancellers comprises:
selecting the combination to include a passive isolator and a feed-forward power amplifier.

30. The non-transitory computer-readable medium of claim 27, wherein the instructions are executable to:
determine that the target interference cancellation is greater than or equal to a threshold; and
wherein selecting the combination of analog interference cancellers comprises:
selecting the combination to include a passive isolator, a feed-forward power amplifier, and an active interference canceller.
